(19) United States
(12) Patent Application Publication
(10) Pub. No.: US 2017/0075653 A1
(43) Pub. Date: Mar. 16, 2017

(54) ELECTRONIC DEVICE AND METHOD FOR CONTROLLING THE ELECTRONIC DEVICE

(71) Applicant: SONY CORPORATION, Tokyo (JP)

(72) Inventors: Frank DAWIDOWSKY, Stuttgart (DE); Michael ENENKL, Stuttgart (DE); Wilhelm HAGG, Korb (DE); Fritz HOHL, Stuttgart (DE); Thomas KEMP, Esslingen (DE)

(73) Assignee: SONY CORPORATION, Tokyo (JP)

(21) Appl. No.: 15/122,733

(22) PCT Filed: Mar. 23, 2015
(86) PCT No.: PCT/EP2015/056061

§ 371 Date: Aug. 31, 2016

(30) Foreign Application Priority Data
Mar. 26, 2014 (EP) 14161852.0

(51) Int. Cl. G06F 3/16; G06F 3/01

(52) U.S. Cl. CPC G06F 3/167; G06F 3/017; H04M 1/72569

(57) ABSTRACT

An electronic device including: a display; and a processor configured to: detect a speech command, and generate a first command menu with a first list of speech commands on detection of a first movement detected by a movement sensor and a second command menu with a second list of speech commands on detection of a second movement.

### TECHNICAL FIELD

The present disclosure generally pertains to an electronic device and a method for controlling the electronic device.

### TECHNICAL BACKGROUND

Generally, it is known to control an electronic device, such as a mobile terminal, by voice input. Typically, a mobile terminal has a display for displaying information and input means for receiving user inputs, e.g. a keypad, touchpad, etc.

In particular, in situations where the user of the electronic device is hindered to make user inputs by hand, voice control is useful for controlling the electronic device.

However, the ability of speech recognition is typically limited to predefined speech commands so that the user has to use the predefined speech commands for controlling the electronic device, which is uncomfortable for the user, since the user has to know in advance the correct speech commands.

Hence, it is generally desirable to improve the voice control of an electronic device.

### SUMMARY

According to a first aspect, the disclosure provides an electronic device, comprising: a display; and a processor configured to: detect a speech command; and generate a first command menu including a first list of speech commands on detection of a first movement detected by a movement sensor and a second command menu including a second list of speech commands on detection of a second movement.

According to a second aspect, the disclosure provides a method for controlling an electronic device, comprising: detecting a movement of the electronic device; detecting a speech command; and generating a first command menu including a first list of speech commands on detection of a first movement and generating a second command menu including a second list of speech commands on detection of a second movement.

Further aspects are set forth in the dependent claims, the following description and the drawings.

### BRIEF DESCRIPTION OF THE DRAWINGS

Embodiments are explained by way of example with respect to the accompanying drawings, in which:

FIG. 1 schematically illustrates an electronic device;

FIG. 2 schematically illustrates the electronic device of FIG. 1 in a three dimensional view;

FIG. 3a illustrates the electronic device tilted about a first angle in a clockwise direction;

FIG. 3b illustrates the electronic device tilted about a second angle in a counterclockwise direction;

FIG. 4a illustrates a main menu which is displayed on a display of the electronic device, when the electronic device is tilted as illustrated in FIG. 3a;

FIG. 4b illustrates a sub menu which is displayed on the display of the electronic device, when the item “CALL” is selected from the main menu;

FIG. 5a illustrates a sub menu which is displayed on the display of the electronic device, when the electronic device is tilted as illustrated in FIG. 3b;

FIG. 5b illustrates another sub menu which is displayed on the display of the electronic device, when the electronic device is tilted as illustrated in FIG. 3b

FIG. 6 illustrates a query whether a new command should be added; and

FIG. 7 illustrates a flow chart of a method for controlling the electronic device.

### DETAILED DESCRIPTION OF EMBODIMENTS

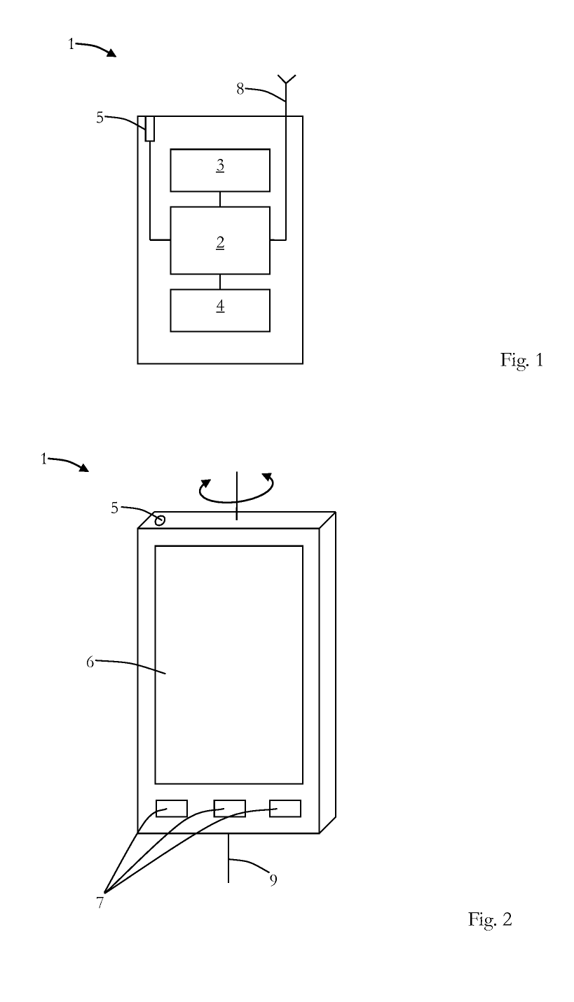

Before a detailed description of the embodiments under reference of FIG. 1, general explanations are made.

As discussed in the outset, for example, in situations where the user of an electronic device is hindered to make user inputs by hand, voice control is useful for controlling the electronic device. However, typically a user of the electronic device has to use predefined speech commands for controlling the electronic device, but, typically, the user does not know the predefined speech commands. Thus, if the user uses an unknown speech command, the electronic device would typically signal that a wrong speech command was used or that the speech command was not correctly detected. Furthermore, in known electronic devices, it is typically not possible to teach new commands or commands which are not correctly detected. In contrast, the speech commands are stored in a predefined and not modifiable list in the electronic device.

Thus, in some embodiments, an electronic device is adapted to detect a movement of the electronic device, e.g. by an included movement sensor which is adapted to output movement data, and it comprises a display, and a processor and some embodiments pertain to a respective method for controlling such an electronic device.

The processor is configured to detect speech commands, for example, in sound wave data received, and to generate a first command menu including a first list of speech commands on detection of a first movement detected by the movement sensor and a second command menu including a second list of speech commands on detection of a second movement. The second list of speech commands can be (at least) partially different from the first list of speech commands in some embodiments or the second list of speech commands can even be totally different from the first list of speech commands. In some embodiments, the first and/or second movement of the electronic device can be detected upon detection of a first and second movement pattern, respectively, in the movement data output from the movement sensor. The first command menu can be of a first command menu type and/or the second command menu can be of a second command menu type.

The following description of embodiments pertains to the electronic device itself as well as to methods for controlling the electronic device.

The electronic device is, for example, a mobile device, such as a mobile terminal, e.g. mobile phone/smartphone or the like, a portable computer, a pocket computer, etc.

The electronic device can also be, for example, a wearable electronic device and/or it can be included in a wearable device which can be worn by a user, e.g. eyewear, wrist watch, (head) camera, bracelet, headset, or the like. In particular for devices which are located at the head of a user, a tilting movement of the electronic device, as also described herein, can be performed by tilting the neck accordingly.

The movement sensor can comprise a gyro sensor, an acceleration sensor, or the like, and it can be adapted to detect movements of the electronic device at least in a plane and/or in three dimensions. The movement sensor can also be adapted to detect an orientation of the electronic device in a plane and/or in three dimensions.

The display of the electronic device can include a liquid crystal display (LCD), an organic light-emitting diode display (OLED), a thin film transistor display (TFT), an active matrix organic light emitting diode display (AMOLED), or the like, and it can include a touchscreen as user input means. The electronic device can also include buttons, a keypad, or the like as user input means in addition to or instead of the touchscreen.

The processor can be a microprocessor, a central processing unit, or the like, and it can include multiple circuits or sub-processors which are adapted to perform specific tasks, such as speech recognition, control of the display, or the like. The electronic device can also include multiple processors as it is generally known in the art.

The sound wave data received in which speed commands can be detected in some embodiments, can origin from a microphone of the electronic device and/or it can be received over an interface, such as a network interface or an universal serial bus interface, etc. The sound wave data can be an analogue signal or a digital signal, which directly or indirectly represents sound waves. The sound waves typically originate from the user of the electronic device who says a speech command in order to control the electronic device. Hence, in some embodiments, the electronic device, i.e. the processor is configured to receive speech commands and to control the electronic device accordingly.

For the detection of speech commands, the processor can be configured to analyze the sound wave data, to detect words and speech commands and to compare it with predefined commands, which are stored, for example, in a vocabulary list in a memory (flash memory, random access memory, read-only memory, or the like), as it is generally known in the art.

The processor is further configured to generate a first command menu (type) including a first list of speech commands on detection of a first movement (e.g. on detection of a first movement pattern in the movement data) and a second command menu (type) including a second list of speech commands on detection of a second movement (e.g. on detection of a second movement pattern).

In some embodiments, the movement data itself can include the first and/or second movement pattern included by the movement sensor in the movement data and/or the processor can analyze the movement data in order to detect the predefined first and/or second movement pattern in the movement data.

The first and second list of speech commands are to be displayed on the display of the electronic device. Hence, the user can cause the processor to display the first list of speech commands or the second list of speech commands on the display by performing the respective first or second predefined movement which generates the respective first and second movements or movement patterns. Thereby, the user can see on the display at least a part of the available speech commands and can accordingly use it.

The first and second movements (movement patterns) can be identical or different. In the case of identical movements (movement patterns), the first command menu (type) is generated when the movement (movement pattern) is detected at the first time and the second command menu (type) is generated when the same movement (movement pattern) is detected in a predefined time interval once more.

When the first and second movements (movement patterns) are different from each other, the first command menu (type) is generated in response to the detection of the first movement (pattern) and the second command menu (type) is generated in response to the detection of the second movement (pattern).

The first command menu (type) can be a main menu, for example a menu including commands causing an action, such as call (call somebody), mail (write email to somebody), etc., and the second command menu (type) can be a sub-menu, for example, including commands pertaining to settings of the electronic device. The first command menu (type) can accordingly include a first list of speech commands including main speech commands, while the second command menu (type) can include a second list of speech commands including sub-speech commands. For example, a main speech command may be the command “call”, while a sub speech command may be the command “volume” with which the volume of a loudspeaker and/or microphone of the electronic device can be adjusted, etc.

The second command menu (type) can also include more detailed commands associated with a command of the first command menu (type). For instance, the first command menu (type) can include a list of speech commands representing basic commands, while the second command menu (type) includes a list of more detailed speech commands, so that the list of speech commands can be expanded in a hierarchical manner on detection of the second movement (movement pattern).

The disclosure is not limited to a first and second command menu (type), but the skilled person will appreciate that the present disclosure can also be expanded to a third, fourth, etc., menu (type), while each menu (type) can be generated and displayed upon detection of a specific movement (movement pattern).

In the following, the description more generally also refers to the “list of speech commands”, which indicates, that the explications pertain to both the first and the second list of speech commands.

The movement (movement pattern) can represent a tilting of the electronic device, an orientation, a lateral/vertical movement, a shaking, a rotation or the like.

In some embodiments, the first movement (pattern) includes a first tilt angle of the electronic device and the second movement (pattern) includes a second tilt angle of the electronic device.

Hence, by tilting the electronic device about a first and a second tilt angle respectively, the user can control whether the first or the second command menu (type) is generated and the associated first or second list of speech commands is displayed.

In some embodiments, the processor is further configured to generate an optical, audio, haptic or other type of signal, in the case that the second type of command menu is not available.

In some embodiments, the processor is further configured to detect, whether a detected speech command is included in the list of speech commands displayed on the display and to control the electronic device in accordance with the detected speech command.

In some embodiments, the processor is further configured to generate a message signal in the case that the detected speech command is not included in the list of speech commands displayed on the display. The message can be a visible message, an audio message, a haptic message, such as a vibration, or the like. Thereby, the user of the electronic devices gets a feedback, whether the speech command transmitted to the electronic device is accepted or not.

In some embodiments, the processor is further configured to adapt the generation of the command menu in accordance with a detected speech command which is not included in the list of speech commands displayed on the display. Thereby, for example, a visual feedback can be given to the user, e.g. by changing the color, the shape or the like of the menu displayed on the display. Additionally, the list of speech commands can be adapted, for instance, by adding a new speech command to the list of speech commands representing the speech command, which is detected and which is not included in the list of speech commands.

In some embodiments, the scope of speech commands which can be detected is limited to the speech commands displayed on the display. Thereby, the risk that the detected speech command is misinterpreted is reduced and the speech recognition is enhanced and becomes more reliable, since the detected speech command must only be compared to the speech commands which are in the list of speech commands (currently) displayed on the display.

In some embodiments, the processor is further configured to associate a detected speech command with a speech command of at least one of the first and second speech command lists. For instance, with an input means such as mentioned above the user can select a respective speech command displayed on the display and can then say a respective speech command which is detected and associated with the selected speech command by the processor. Thereby, the user can adapt the detected speech commands to his personal wishes.

In some embodiments, the processor is further configured to adapt at least one of the first and second speech command lists in accordance with a user input. The user can amend, remove and/or add a speech command and thereby adapt the first and/or second list of speech commands to its own preferences. As mentioned above, in some embodiments, additionally, the processor is configured to “learn” new speech commands, so that the user can also adapt the speech commands detected in association with the speech commands of the first and/or second list of speech commands.

In some embodiments, the processor is further configured to monitor a usage frequency of at least one speech command of at least one of the first and second speech command lists. The processor can also be configured to adapt the list of speech commands in accordance to the usage frequency of a specific speech command. For example, a speech command which is often used can be listed in a top position of the list, e.g. in the first or second position, while a speech command which is rarely used can be listed in a bottom position of the list, e.g. in the last position, or the speech command can even be omitted from the list in the case that all positions of the list of speech commands are already occupied with speech commands which are used more often.

In some embodiments, the processor is further configured to monitor an association between different detected speech commands and an associated speech command of the first or second list of speech commands. Thereby, it can be detected that a user uses different spoken speech commands for selecting a specific associated speech command from the first or second list of speech commands and/or it can be detected that a user uses a sequence of spoken speech commands in order to cause a certain control action. In some embodiments, the processor is further configured to generate a suggestion for a new speech command on the basis of the detected association between different detected speech commands and the associated speech command. If the user accepts the suggested new speech command, e.g. by confirming a respective dialogue displayed on the display, the new speech command will be added to the respective list of speech commands. The usage frequency of the new speech command can be monitored by the processor and, for example, in the case that the user does not use the new speech command, but the sequence of speech commands, the processor can generate and display a respective message informing the user about the new speech command and/or the new speech command can be highlighted, e.g. by displaying it with a different font, font size, color or the like than the other speech commands.

For generation of the name of the new speech command, the processor can be configured to use a generic name, such as “new command” or a generic name with a number, e.g. “command(2)”, it can be configured to take a name from a predefined list, e.g. “John”, and/or the processor can be configured to use Natural Language Processing techniques and to query a database and/or to perform an internet search for finding a term that subsumes the detected sequence of speech commands used by the user. For communication with the database and/or the internet, the electronic device can include an interface, such as a network interface, a wireless interface, a mobile communication interface or the like. The processor can also be configured to query the user to input a name for the new command.

Returning to FIGS. 1 and 2, they illustrate schematically an embodiment of an electronic device in the form a mobile terminal 1, wherein, as mentioned above, the present disclosure is not limited to mobile terminals.

The mobile terminal 1 has a processor 2 which is connected to a movement sensor 3, a memory 4, a microphone 5 and an antenna 8.

The mobile terminal 1 has a display which is configured as a touchscreen 6 and it has a keypad 7 with three buttons. A user of the mobile terminal 1 can input commands over the touchscreen 6 and over the keypad 7.

The movement sensor 3 includes gyro sensors and acceleration sensors, so that the movement sensor 3 can detect movements, accelerations, rotations and the orientation of the mobile terminal 1.

The movement sensor 3 generates respective movement data which are representative of the movements, accelerations, rotations and the orientation of the mobile terminal 1, and transmits the movement data to the connected processor 2 for further analysis.

The microphone 5 receives sound waves which origin from the user of the mobile terminal 1 who orally gives speech commands in order to control the mobile terminal 1. The microphone 5 generates sound wave data which are transmitted to the processor 2. In the present embodiment the microphone 5 performs an analog-to-digital conversion of the received sound waves and transmits digital sound wave data to the processor 2 for further analysis, without limiting the present disclosure to this specific embodiment.

The processor 2 communicates over antenna 8 with a mobile communication network, as it is known in the art. Moreover, the mobile terminal 1 is configured to communicate wireless over a WLAN interface (Wireless Local Area Network, not shown), as it is known in the art.

The memory 4 has a ROM-part (Read Only Memory) and a RAM-part (Random Access Memory) and it stores data and program code, etc., which is needed by the processor 2 and/or which causes the processor 2 to perform the respective methods described herein.

The mobile terminal 1 is adapted to be controlled by speech commands originating from the user of the mobile terminal 1.

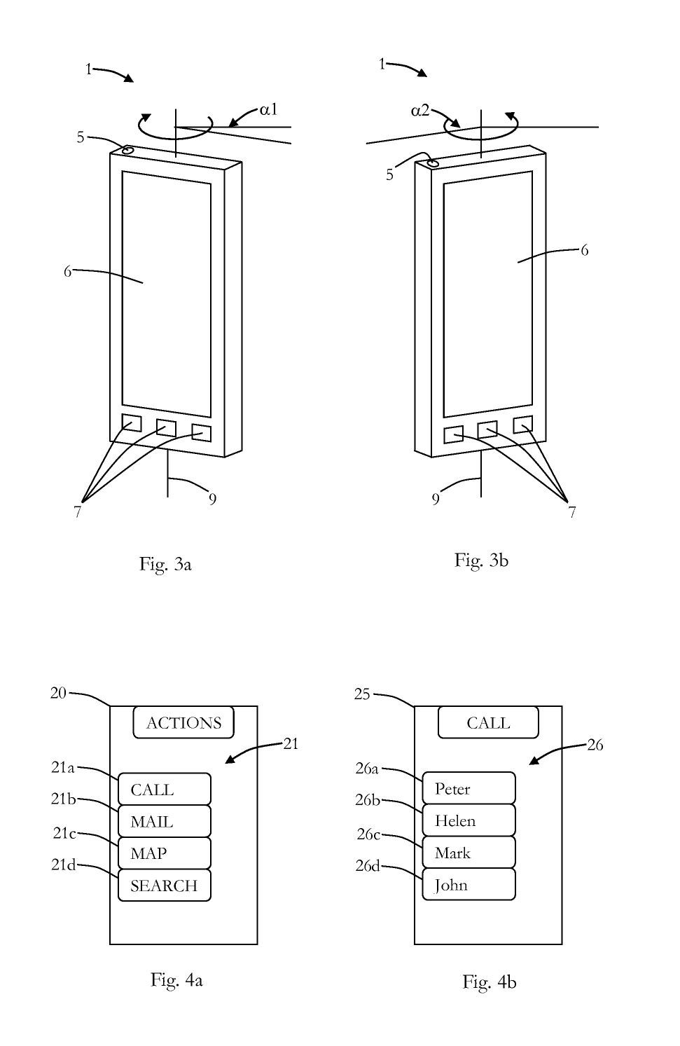

In order to give the user an overview of available speech commands, the processor 2 generates and displays a main menu 20 (FIG. 4a) when the mobile terminal 1 is rotated clockwise about a vertical rotation axis 9 and is thereby tilted about a first angle α1, as illustrated in FIG. 3a. The clockwise rotation about the vertical rotation axis 9 is detected by the movement sensor 3 as a first movement type which in turn transmits respective movement data to the processor 2. The processor 2 analyzes the received movement data and detects that the mobile device 1 is clockwise rotated about the first angle α1 and generates and displays the main menu 20 in response to that rotating movement on the touchscreen 6.

The main menu 20 has the heading “ACTIONS” and it includes a list 21 of speech commands 21a to 21d which are available to the user, namely “CALL” 21a, “MAIL” 21b, “MAP” 21c, and “SEARCH” 21d. Of course, the main menu 20 and the list 21 of speech commands 21a to 21d is only an example, and the skilled person will appreciate that the main menu 20 as well as the list 21 of speech commands 21a to 21d can be adapted to specific purposes, if needed.

Hence, the user only needs to rotate the mobile terminal 1 in a clockwise manner about the angle α1 in order to cause the processor 2 to display the main menu 20 with the list 21 of available speech commands 21a to 21d.

Then, the user only needs to say the respective speech command, e.g. “CALL”, so that the sound waves are received by the microphone 5 which in turn generates and transmits respective sound wave data to the processor 2, which in turn detects the speech command “CALL” in the sound wave data received from the microphone 5 and executes the respective command. Of course, the user can also choose the command “CALL” by tapping, for example, on the touchscreen 6.

Upon detection of the speech command “CALL”, the processor generates and displays a respective sub menu 25 “CALL”, as illustrated in FIG. 4b. The sub menu 25 “CALL” has a list 26 of further speech commands 26a to 26d, which are in this case names of persons who can be called, namely Peter 26a, Helen 26b, Mark 26c and John 26d. Of course, the sub menu 25 and the list 26 of speech commands 26a to 26d is only an example, and the skilled person will appreciate that the sub menu 25 as well as the list 26 of speech commands 26a to 26d can be adapted to specific purposes, if needed. The user can then call, for example, “Peter” by saying the respective speech command “Peter” or by tapping on the item “Peter” 26a as displayed on the touchscreen 6.

Accordingly, a sub menu related to sending of an email is generated, when the speech command “MAIL” is detected, a sub menu related to displaying a map is generated, when the speech command “MAP” is detected, and a sub menu related to invoking an internet search is generated, when the speech command “SEARCH” is detected, etc.

In the present embodiment, the scope of available speech commands is limited to the speech commands displayed on the touchscreen 6, in order to enhance the recognition accuracy.

In the case that the processor 2 detects a speech command in the received sound wave data, the detection is acknowledged to the user by highlighting the respective command on the touchscreen (changing color) and by generating a respective acknowledged sound.

In the case that the user decides not to call, he can turn the mobile terminal 1 back, i.e. counter-clockwise, roughly about the first tilt angle into the normal position. This movement is detected by the movement sensor 3 which transmits the corresponding movement data to the processor 2, which in turn detects the backward movement of the mobile terminal 1 and generates and displays the main menu 20 again on the touchscreen 6. Thereby, a forward and backward navigation between the main menu 20 and the sub menu 25 is implemented.

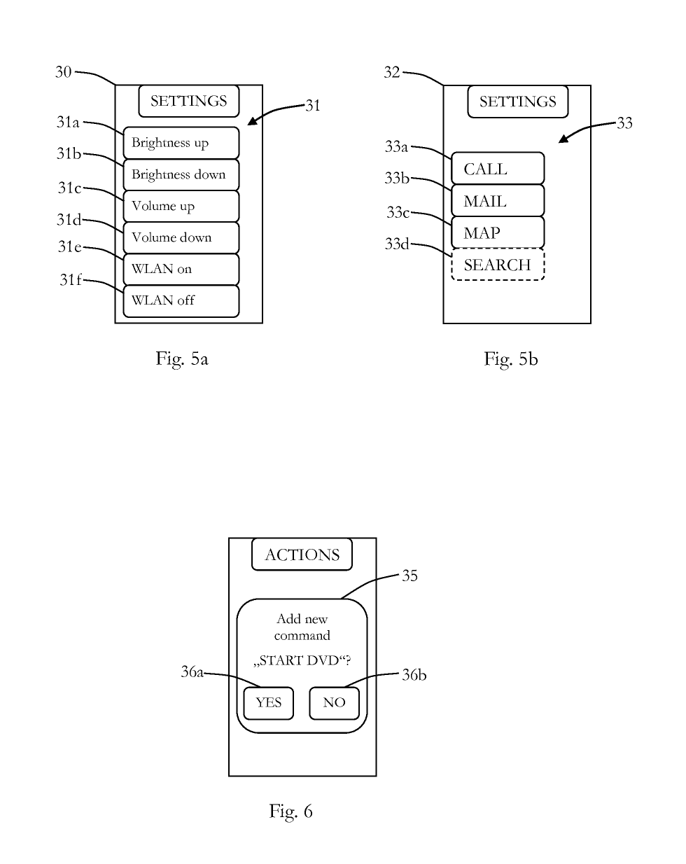

When the user turns the mobile terminal 9 counterclockwise around the vertical axis 9 about a second angle α2 a second movement type is detected and another (second type) sub menu 31 (FIG. 5) is generated by the processor 2 and displayed on the touchscreen 6. In the present embodiment, the sub menu 31 is a “SETTINGS” menu which includes speech commands allowing to adapt the settings of the mobile terminal 1. The settings sub menu 30 has a list 31 of speech commands 31a to 31f, namely “Brightness up” 31a for increasing the brightness of the touchscreen 6, “Brightness down” 31b for decreasing the brightness of the touchscreen 6, “Volume up” 31c for increasing the loudness of a loudspeaker of mobile terminal 1, “Volume down” 31d for decreasing the loudness of a loudspeaker of mobile terminal 1, “WLAN on” 31e for turning on the WLAN interface, and “WLAN off” 31f for turning off the WLAN interface.

The user can select one of the speech commands 31a to 31f of the list 31 of speech commands by saying the respective command or by tapping on the respective command as displayed on the touchscreen 31.

In the embodiment of FIG. 5a, the list of speech commands 31 is totally different from the list of speech commands 21 of the main menu 20. In other embodiments, the list of speech commands displayed upon detection of the first and second movement, respectively, differ only partially from each other.

FIG. 5b shows exemplary a further sub menu 32 which is displayed upon detection of the second movement, e.g. a counterclockwise rotation around the vertical axis 9 about a second angle α2. The sub menu 32 is a another “SETTINGS” menu having a list of speech commands 33 which includes three speech commands, namely “CALL” 33a, “MAIL” 33b and “MAP” 33c, which are identical to the three items “CALL” 21a, “MAIL” 21b and “MAP” 21c of the main menu 20. The item “SEARCH” 21d is missing on the list of speech commands 33 of the “SETTINGS” sub menu 32 in this example, so that the list of speech commands 21 of the main menu 20 and the list of speech commands 33 of the sub menu 32 are only partially identical.

When the sub menu 32 “SETTINGS” is displayed and the user says any speech command of the list of speech commands 33, a respective settings menu is displayed where general settings can be made. For instance, in the case that the command “CALL” is detected, general settings for making a call can be set (e.g. whether the number of the caller is transmitted, etc.), in the case that the command “MAIL” is detected, general mail settings can be made (e.g. from which mail account a mail should generally be sent) and in the case that the command “MAP” is detected general map settings can be made (e.g. whether a street map or a photographic map shall be displayed).

In still other embodiments, the list of speech commands of the menus displayed upon detection of the first and second movement can even be identical, as it is indicated for the list of speech commands 33 of the “SETTINGS” sub menu 32 where the further item “SEARCH” 33d is shown which a dashed line. In such an embodiment the list of speech commands 33 has the same speech commands “CALL” 33a, “MAIL” 33b, “MAP” 33c and “SEARCH” 33d as the main menu 20 of FIG. 4a which also has the speech commands “CALL” 21a, “MAIL” 21b, “MAP” 21c and “SEARCH” 21d. Of course, it makes a difference whether a user uses a speech command from the list of speech commands 21 of the main menu 20 or from list of speech commands 33 of the sub menu 32. For example, if the speech command “CALL” from the main menu 20 displayed on the display 6 is detected, the sub menu 25 of FIG. 4b is displayed as discussed above. However, if the speech command “CALL” from the sub menu 32 displayed on the display 6 is detected, a settings menu is displayed, where general call settings can be made, as discussed above.

In some embodiments, the movement of the mobile terminal 1 can also be in the opposite way as explained in connection with FIGS. 3a and 3b, i.e. on detection of a counterclockwise rotation about a first angle α1 the main menu 20 is displayed, and on clockwise rotation about a second angle α2 the sub-menu 31 is displayed. As also mentioned above, instead or in addition to the tilting of the mobile terminal 1, alternatively the tilting can be replaced by other actions that can be detected by the movement sensor 3, e.g. by a vigorous shake, by a quick movement (acceleration) to the left or the right, or the like.

Additionally, in some embodiments, instead of (or in addition to) turning the mobile terminal 1 counterclockwise around the second angle α2, as illustrated in FIG. 3b, a list of speech commands may also be expanded in a hierarchical way by turning the mobile terminal 1 clockwise around an angle which is larger than the first angle α2. Hence, the main menu 20 with a list 21 of basic or action speech commands 21a to 21d will be available at the smaller first angle α1 of tilt, and the more advanced sub menu, such as sub menu 30 as illustrated in FIG. 5, will be generated and displayed at a tilt angle which is larger than the first tilt angle α1.

In order to signal to the user that all possible speech commands in a certain context are already displayed on the touchscreen 6, the processor 2 could generate a respective message signaled to the user, such as a vibration signal, a respective message displayed on the touchscreen 6 or the like.

Additionally, the sub 30 or main menu 20 might optionally change by moving the mobile terminal 1 in any other direction. By this means it is possible to easily expand and group the speak-able speech commands in some embodiments.

The processor 2 is additionally configured to learn new speech commands. In case of a not recognized speech command, the user can repeat saying the speech command and can simultaneously push the according speech command as displayed on the touchscreen 6.

For example, the user says the speech command “send mail”, but the generic command is “MAIL”, as can be taken from the list 21 of the main menu 20 (see speech command “MAIL” 21b). In this specific example, the user is using “send mail” as his personal preference and he would like to use this command instead of the generic “MAIL”. Since “MAIL” is one of the possible speech commands of the main menu 20, he will see it in the list 21 of possible speech commands, when he turns the mobile terminal 1 clockwise around the first angle α1, as shown in FIG. 3a and as discussed above. By saying “send mail” and then tapping the touchscreen 6 at the location, where the speech command “MAIL” 21b is displayed, the user indicates that the words “send mail” should be associated with the speech command “MAIL”. The processor 2 stores this association in the memory 4 and the processor adds the words “send mail” to a speech command vocabulary stored in the memory 4, so that from this point on, the user can use both the speech commands “MAIL” and the new learned speech command “send mail” with the same effect.

The processor 2 monitors the usage frequency of the new command “send mail”, so that when later the same speech command “send mail” is used again and again, the processors 2 can adapt its speech recognition to this new speech command and can learn the relation between the user voice input and the related menu item, i.e. the speech command “MAIL” 21b, thereby improving the speech recognition accuracy.

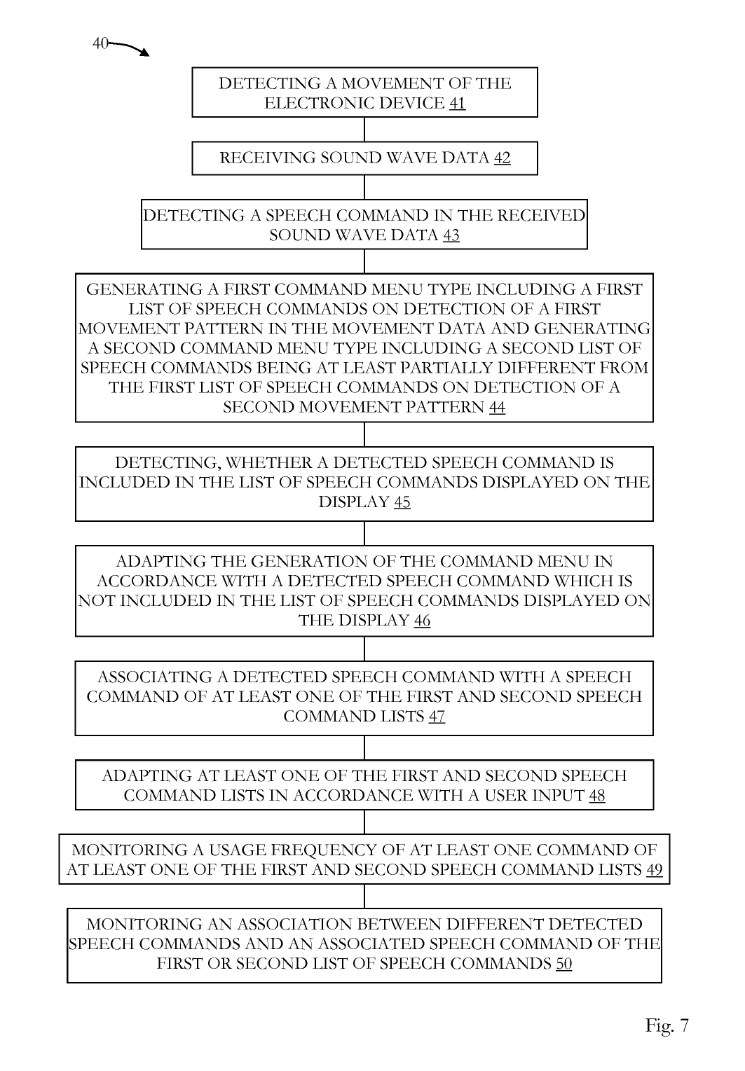

In order to prevent the system from learning unintended relations, the processor 2 generates a query, such as a query 35 as will also be explained in connection with FIG. 6 below, and/or the processor 2 may request e.g. that the user repeats the same new speech command twice in order to indicate that he wants the processor 2 to learn it now.

Moreover, the user can add a new speech command to the list 21 of the main menu or to one of the sub menus 25 and 30 and can associate it with an action of the mobile terminal 1, e.g. by inputting a new speech command which will be added to a list of speech commands or which will replace an existing speech command from a list. For instance, the user can add the speech commands “Volume up” 31c and “Volume down” 31d from the settings sub menu 30 to the main menu 20.

The user can also modify the content of an existing menu, such as main menu 20 or sub menu 25 or 30, to adapt the respective menu to his needs.

The processor 2 can also monitor the usage frequency of speech commands and can insert, for example, speech commands which have been frequently used in the past into the main menu 20, and it can shift speech commands which have been rarely used, for example, from the main menu 20 to a sub menu, while this sub menu can be displayed, for example, by tilting the mobile terminal 1 around a second tilt angle which is larger than the first tilt angle α1 or by any other specific movement (e.g. by shaking the mobile phone 1, when the main menu 20 is displayed or the like). Thereby, an adaptive and personalized behavior of the user interface of the mobile terminal 1 is achieved, with the most useful speech commands appearing first (e.g. in the main menu 20) by tilting the mobile terminal 1 about the first angle α1, and the more specialized speech commands appearing at a larger tilt angle depending on the usage by this particular user.

Furthermore, the processor 2 can detect when the user frequently uses a sequence of commands in order to achieve a single aim. This can be detected by the processor 2, for example, when there is no significant pause between the respective speech commands. For example, in the case that the user uses the sequence “start DVD player”, “set TV input to HDMI” or “play DVD”, the processor 2 detects that these speech command sequences have a single aim, namely to start the play of a DVD.

In such a case, the processor 2 can propose a new speech command, such as “START DVD” which can be used instead of (or in addition to) the sequences of speech commands “start DVD player”, “set TV input to HDMI” or “play DVD”.

The processor 2 can generate a respective query 35 displayed on touchscreen 6, as illustrated in FIG. 6, where the user is asked to confirm or deny that the new speech command “START DVD” is added to a speech command list, such as list 21 of the main menu 20, by either tapping on the item “YES” 36a displayed on the touchscreen 6 for confirmation or item “NO” 36b for denying.

If the user accepts the new speech command “START DVD” by tapping on “YES” 36a, this new speech command is added to the speech command list 21 of the main menu 20 in the present example, without limiting the present disclosure to this specific example.

In the present embodiment, the processor 2 additionally monitors the usage of the new speech command “START DVD”. If, instead of the new speech command “START DVD”, one of the speech command sequences “start DVD player”, “set TV input to HDMI” or “play DVD” is used, which should be replaced by the new speech command “START DVD”, the processor 2 reminds the user that there is the new speech command “START DVD” available by generating and displaying a respective message.

For generating a new name for the new speech command, several strategies can be performed by processor 2.

First, a generic name taken from a predefined list can be used. In the above example, this could be “DVD” or in the case that a specific person is frequently called, the name of the person could be taken, e.g. from the address list, such as “John” (see also 26d in FIG. 4b) stored in memory 4.

Secondly, e.g. in cases where a predefined list is not available, the processor can generate a name on the basis of a generic name plus a number, for example, “command2”, etc.

Thirdly, when an internet connection is available, the system can employ Natural Language Processing techniques to query a database or it can perform an internet search for a term that subsumes the names of the replaced commands. For example, the processor 2 can search for terms subsuming the words “play”, “TV”, “HDMI”, etc., which might result in “start” and “DVD” as alternative terms.

Finally, the processor 2 can generate a query asking the user to input the name of the new speech command, such as “START DVD” as discussed above.

A method for controlling an electronic device, such as mobile terminal 1 discussed above, is described in the following and under reference to FIG. 7. The method can also be implemented as a computer program causing a computer and/or a processor, such as processor 2 discussed above, to perform the method, when being carried out on the computer and/or processor. In some embodiments, also a non-transitory computer-readable recording medium is provided that stores therein a computer program product, which, when executed by a processor such as the processor described above, causes the method described to be performed.

At 41, a movement of the electronic device is detected as discussed above, for example, in connection with the movement sensor 3.

At 41, sound wave data are received, e.g. via a microphone 5, as discussed above.

At 43, a speech command is detected in the received sound wave data.

At 44 a first command menu type including a first list of speech commands is generated on detection of a first movement pattern in the movement data and a second command menu type including a second list of speech commands being at least partially different from the first list of speech commands is generated on detection of a second movement pattern.

The first movement pattern can include a first tilt angle of the electronic device, such as angle α1 described above, and the second movement pattern can include a second tilt angle of the electronic device, such as angle α2 describe above.

At 45 it is detected, whether a detected speech command is included in the list of speech commands displayed on a display of the electronic device. If the speech command is included, it is executed and the electronic device is controlled accordingly.

At 46, a message signal is generated in the case that the detected speech command is not included in the list of speech commands displayed on the display of the electronic device.

At 47, the generation of the command menu is adapted in accordance with a detected speech command which is not included in the list of speech commands displayed on the display. Thereby, for example, a new speech command can be added to the list of speech commands, as discussed above.

As discussed above, the scope of speech commands which can be detected can be limited to the speech commands displayed on the display, thereby the speech recognition can be improved.

At 47 a detected speech command is associated with a speech command of at least one of the first and second speech command lists. Thereby, the user can associate an own (spoken) speech command with a predefined speech command on the first/second list of speech commands, as discussed above.

At 48, at least one of the first and second speech command lists is adapted in accordance with a user input. Hence, the user can amend the first and/or second speech command list in accordance with own preferences, as discussed above.

At 49, a usage frequency of at least one command of at least one of the first and second speech command lists is monitored, as discussed above. Thereby, frequently used speech commands can be identified and the first/second list of speech commands can be adapted accordingly, for example, by ordering the speech commands in accordance with their usage.

At 50, an association between different detected speech commands and an associated speech command of the first or second list of speech commands can be monitored, thereby it can be detected, whether a sequence of speech commands is frequently used with a certain aim, as discussed above.

Note that the present technology can also be configured as described below.

(1) An electronic device, comprising:
a display; and
a processor configured to:
detect a speech command; and
generate a first command menu including a first list of speech commands on detection of a first movement detected by a movement sensor and a second command menu including a second list of speech commands on detection of a second movement.

(2) The electronic device according to (1), wherein the first list of speech commands is partially different from the second list of speech commands or totally different from the second list of speech commands.

(3) The electronic device according to (1) or (2), wherein the first movement includes a first tilt angle of the electronic device and the second movement includes a second tilt angle of the electronic device.

(4) The electronic device according to anyone of (1) to (3), wherein the processor is further configured to detect, whether a detected speech command is included in the list of speech commands displayed on the display.

(5) The electronic device according to (4), wherein the processor is further configured to generate a message signal in the case that the detected speech command is not included in the list of speech commands displayed on the display.

(6) The electronic device according to anyone of (4) and (5), wherein the processor is further configured to adapt the generation of the command menu in accordance with a detected speech command which is not included in the list of speech commands displayed on the display.

(7) The electronic device according to anyone of (1) to (6), wherein the scope of speech commands which can be detected is limited to the speech commands displayed on the display.

(8) The electronic device according to anyone of (1) to (7), wherein the processor is further configured to associate a detected speech command with a speech command of at least one of the first and second speech command list.

(9) The electronic device according to anyone of (1) to (8), wherein the processor is further configured to adapt at least one of the first and second speech command lists in accordance with a user input.

(10) The electronic device according to anyone of (1) to (9), wherein the processor is further configured to monitor a usage frequency of at least one speech command of at least one of the first and second speech command lists.

(11) The electronic device according to anyone of (1) to (10), wherein the processor is further configured to monitor an association between different detected speech commands and an associated speech command of the first or second list of speech commands.

(12) A method for controlling an electronic device, comprising:
detecting a movement of the electronic device;
detecting a speech command; and
generating a first command menu including a first list of speech commands on detection of a first movement and generating a second command menu including a second list of speech commands on detection of a second movement.

(13) The method of (12), wherein the first list of speech commands is partially different from the second list of speech commands or totally different from the second list of speech commands.

(14) The method of (12) or (13), wherein the first movement includes a first tilt angle of the electronic device and the second movement includes a second tilt angle of the electronic device.

(15) The method of anyone of (12) to (14), further comprising detecting, whether a detected speech command is included in the list of speech commands displayed on the electronic device.

(16) The method of (15), further comprising generating a message signal in the case that the detected speech command is not included in the list of speech commands displayed on the electronic device.

(17) The method according to anyone of (15) and (16), further comprising adapting the generation of the command menu in accordance with a detected speech command which is not included in the list of speech commands displayed on the electronic device.

(18) The method according to anyone of (12) to (17), wherein the scope of speech commands which can be detected is limited to the speech commands displayed on the electronic device.

(19) The method according to anyone of (12) to (18), further comprising associating a detected speech command with a speech command of at least one of the first and second speech command lists.

(20) The method according to anyone of (12) to (19), further comprising adapting at least one of the first and second speech command lists in accordance with a user input.

(21) The method according to anyone of (12) to (20), further comprising monitoring a usage frequency of at least one command of at least one of the first and second speech command lists.

(22) The method according to anyone of (12) to (21), further comprising monitoring an association between different detected speech commands and an associated speech command of the first or second list of speech commands.

(23) A computer program comprising program code causing a computer to perform the method according to anyone of (12) to (22), when being carried out on a computer.

(24) A non-transitory computer-readable recording medium that stores therein a computer program product, which, when executed by a processor, causes the method according to anyone of (12) to (22) to be performed.

1. An electronic device, comprising:
a display; and
a processor configured to:
detect a speech command; and
generate a first command menu including a first list of speech commands on detection of a first movement detected by a movement sensor and a second command menu including a second list of speech commands on detection of a second movement.

2. The electronic device according to claim 1, wherein the first list of speech commands is partially different from the second list of speech commands or totally different from the second list of speech commands.

3. The electronic device according to claim 1, wherein the first movement includes a first tilt angle of the electronic device and the second movement includes a second tilt angle of the electronic device.

4. The electronic device according to claim 1, wherein the processor is further configured to detect, whether a detected speech command is included in the list of speech commands displayed on the display.

5. The electronic device according to claim 4, wherein the processor is further configured to generate a message signal in the case that the detected speech command is not included in the list of speech commands displayed on the display.

6. The electronic device according to claim 4, wherein the processor is further configured to adapt the generation of the command menu in accordance with a detected speech command which is not included in the list of speech commands displayed on the display.

7. The electronic device according to claim 1, wherein the scope of speech commands which can be detected is limited to the speech commands displayed on the display.

8. The electronic device according to claim 1, wherein the processor is further configured to associate a detected speech command with a speech command of at least one of the first and second speech command list.

9. The electronic device according to claim 1, wherein the processor is further configured to adapt at least one of the first and second speech command lists in accordance with a user input.

10. The electronic device according to claim 1, wherein the processor is further configured to monitor a usage frequency of at least one speech command of at least one of the first and second speech command lists.

11. A method for controlling an electronic device, comprising:
detecting a movement of the electronic device;
detecting a speech command; and
generating a first command menu including a first list of speech commands on detection of a first movement and generating a second command menu including a second list of speech commands on detection of a second movement.

12. The method of claim 11, wherein the first list of speech commands is partially different from the second list of speech commands or totally different from the second list of speech commands.

13. The method of claim 11, wherein the first movement includes a first tilt angle of the electronic device and the second movement includes a second tilt angle of the electronic device.

14. The method of claim 11, further comprising detecting, whether a detected speech command is included in the list of speech commands displayed on the electronic device.

15. The method of claim 14, further comprising generating a message signal in the case that the detected speech command is not included in the list of speech commands displayed on the electronic device.

16. The method of claim 14, further comprising adapting the generation of the command menu in accordance with a detected speech command which is not included in the list of speech commands displayed on the electronic device.

17. The method of claim 11, wherein the scope of speech commands which can be detected is limited to the speech commands displayed on the electronic device.

18. The method of claim 11, further comprising associating a detected speech command with a speech command of at least one of the first and second speech command lists.

19. The method of claim 11, further comprising adapting at least one of the first and second speech command lists in accordance with a user input.

20. The method of claim 11, further comprising monitoring a usage frequency of at least one command of at least one of the first and second speech command lists.
